(19) United States
(12) Patent Application Publication
(10) Pub. No.: US 2011/0281139 A1
(43) Pub. Date: Nov. 17, 2011

(54) Wastewater Treatment Process and Device for Electricity Generation and Desalination Simultaneously

(75) Inventors: Xia Huang, Beijing (CN); Xiaoxin Cao, Beijing (CN); Peng Liang, Beijing (CN); Kang Xiao, Beijing (CN); Yingjun Zhou, Beijing (CN); Bruce Logan, University Park, PA (US)

(73) Assignee: Tsinghua University, Beijing (CN)

(21) Appl. No.: 13/145,987

(22) PCT Filed: Jan. 23, 2009
(86) PCT No.: PCT/CN09/00111

§ 371 Date: Jul. 22, 2011

(51) Int. Cl. H01M 8/16; C02F 1/469

(52) U.S. Cl. 429/2; 204/522; 204/633; 204/533

(57) ABSTRACT

A wastewater treatment process and wastewater treatment device for generating current and desalting simultaneously are provided. The device may comprise an anode compartment, an anion exchange membrane, a middle desalting compartment, a cation exchange membrane and a cathode compartment. Wastewater flows into the anode compartment, and is oxidized under the action of an electricigenic microbe. In the desalting compartment, anions are transferred to the anode compartment through the anion exchange membrane, and cations are transferred to the cathode compartment through the cation exchange membrane, thus achieving a desalting process and forming an internal current. Electrons are transferred to the cathode through an external circuit such that a reduction reaction takes place and a current generation is achieved. The wastewater treatment, the current generation and the desalination are achieved simultaneously in the process.

### FIELD

The present disclosure generally relates to the field of water treatment, more particularly, to a wastewater treatment process and a wastewater treatment device for generating current and desalting simultaneously.

### BACKGROUND

The statements in this section merely provide background information related to the present disclosure and may or may not constitute prior art.

Water is an important natural resource for human survival. As global water environment deteriorates and energy crisis becomes serious, there is an urgent need for a wastewater recycling technology with high efficiency and low consumption to alleviate water shortage and meet the requirement for energy. Since 97% of all the water on earth is saline water comprising sea water and brackish water, fresh water is acquired by desalting saline water from the sea and salina to alleviate increasingly serious worldwide water crisis, which has been not only a consensus in global scientific communities but also a government assertion of every country with sea coasts and a countermeasure of developing new water sources. At present, sea water desalination has been all over 125 countries and regions in the world, and desalinized water supports about 5% of the population in the world. Main desalination processes comprise a distillation method, an electrodialysis method, an ultrafiltration-reverse osmosis method, etc. These processes have high treatment efficiencies whereas the power consumption thereof is high.

A microbial fuel cell (MFC) is a novel wastewater treatment technology developed recently, and a conventional microbial fuel cell consists of an anode, a barrier and a cathode. The basic principle of the MFC lies in the fact that under the action of electricigenic microbes, contaminants are removed by anode oxidizing, and the chemical energy thereof is converted into electric energy, thus generating current while treating wastewater. From 2002 to the present, the output power of MFC has been increased by nearly ten thousand times, which shows a bright perspective in application. A conventional research approach to the MFC is to utilize a current in an external circuit. However, there is an identical internal current in an internal circuit. By virtue of electrodialysis principle, a cation exchange membrane and an anion exchange membrane are used instead of a single cation exchange membrane to form a middle compartment, and saline water is introduced into the middle compartment, so that the internal current of MFC may be utilized so as to treat wastewater, generate current and desalt simultaneously.

### SUMMARY

The present disclosure is directed to use MFC to treat wastewater, generate current and desalt simultaneously based on a microbial fuel cell technology.

According to an aspect of the present disclosure, a wastewater treatment process for generating current and desalting simultaneously is provided, comprising steps of: (a) providing a device; (b) oxidizing wastewater flowing into an anode compartment A under the action of electricigenic microbes to remove contaminants from the wastewater, transferring electrons in a respiratory chain of the electricigenic microbes to an anode 4, and a current in an external circuit flowing from a cathode 5 to the anode 4; (c) a current in an internal circuit flowing from the anode 4 to the cathode 5, saline water continuously flowing into a middle desalting compartment B, and due to the selectivity of an anion exchange membrane 2 and a cation exchange membrane 3, transferring anions and cations to the anode compartment A and a cathode compartment C through the anion exchange membrane 2 and the cation exchange membrane 3 under the action of an electric driving force respectively to achieve a desalting process; and (d) combining electrons in the external circuit transferred to the cathode 5 with an electron acceptor to complete a reduction reaction, thus achieving current generation.

In some embodiments, the wastewater is organic wastewater capable of being treated biochemically.

In some embodiments, the electricigenic microbe may comprise Geobacter and Shewanella.

In some embodiments, the saline water comprises: sea water or brackish water with a salt content of 5-35 g/L.

In some embodiments, the electron acceptor comprises oxygen and potassium ferricyanide for chemically catalytic reduction as well as oxygen, nitrate and carbon dioxide for microbially catalytic reduction.

According to another aspect of the present disclosure, a wastewater treatment device for generating current and desalting simultaneously is provided, in which a microbial fuel cell 1 is divided into an anode compartment A, a middle desalting compartment B and a cathode compartment C by an anion exchange membrane 2 and a cation exchange membrane 3; and an anode 4 is disposed in the anode compartment A, a cathode 5 is disposed in the cathode compartment C, and an electricigenic biofilm 6 is disposed on the anode 4.

In some embodiments, the anion exchange membrane 2 and the cation exchange membrane 3 are a non-toxic industrial electrodialysis ion exchange membrane with a transmissivity not less than 90%, a thickness of 0.2-0.5 mm, and a bursting strength not less than 0.3 MPa.

In some embodiments, the electricigenic biofilm 6 on the anode 4 has a thickness of 20-80 μm.

In some embodiments, the anode 4 and a filling material in the anode compartment A comprise graphite particles or carbon felt with a particle diameter of 1-5 mm

In some embodiments, the cathode 5 and a filling material in the cathode compartment C comprise graphite particles or carbon felt with a particle diameter of 1-5 mm

With the wastewater treatment process and the wastewater treatment device according to an embodiment of the present disclosure, the internal current of the microbial fuel cell (MFC) is utilized to treat wastewater, generate current and desalt simultaneously. The wastewater treatment process according to an embodiment of the present disclosure is simple, easy to operate with low energy consumption and high efficiency. The wastewater treatment device according to an embodiment of the present disclosure is simple in structure and convenient for production and application in related industry.

### BRIEF DESCRIPTION OF THE DRAWINGS

FIG. 1 is a schematic view showing a principle of a microbial desalination cell according to an embodiment of the present disclosure.

Reference signs: 1—microbial fuel cell; 2—anion exchange membrane; 3—cation exchange membrane; 4—anode; 5—cathode; 6—electricigenic biofilm.

### DETAILED DESCRIPTION

A wastewater treatment process and a wastewater treatment device for generating current and desalting simultaneously are provided. Reference will be made in detail to embodiments of the present disclosure.

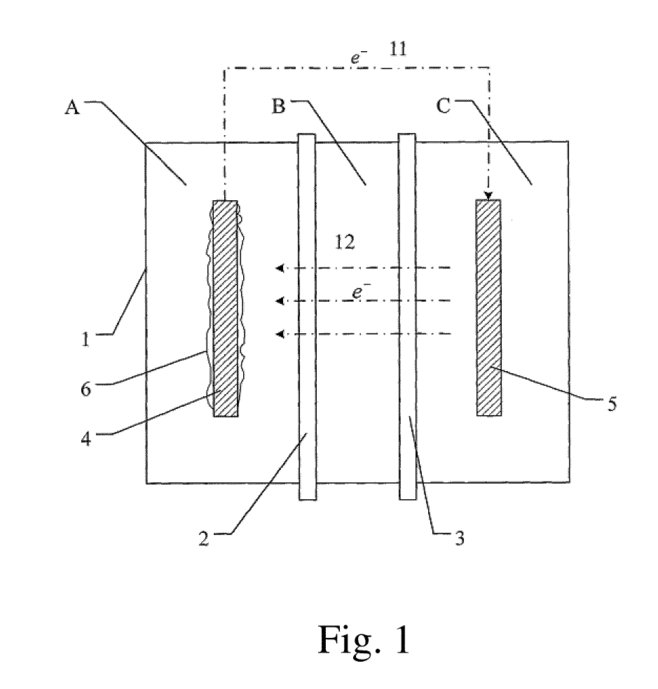

FIG. 1 is a schematic view showing a principle of a microbial desalination cell according to an embodiment of the present disclosure. A microbial fuel cell 1 is divided into an anode compartment A, a middle desalting compartment B and a cathode compartment C by an anion exchange membrane 2 and a cation exchange membrane 3. The anion exchange membrane 2 and the cation exchange membrane 3 are non-toxic industrial electrodialysis ion exchange membranes with a transmissivity of 95%, a thickness of 0.3 mm, and a bursting strength of 0.5 MPa. An anode 4 is disposed in the anode compartment A, a cathode 5 is disposed in the cathode compartment C, and an electricigenic biofilm 6 with a thickness of 40 μm is disposed on the anode 4. The electricigenic microbe is Geobacter. Each of the anode 4, the cathode 5, and filling materials in the anode compartment A and the cathode compartment B is carbon felt with a particle diameter of 1-5 mm. The filling materials of the anode compartment A and the cathode compartment B may increase the adhesion area of the electricigenic microbe and the cathode area, thus increasing the current accordingly.

After the device for generating current and desalting simultaneously is provided, the anode compartment A is kept under anaerobic conditions, organic wastewater capable of being treated biochemically flows into the anode compartment A, and is oxidized under the action of the electricigenic microbes to remove contaminants from the wastewater, electrons in a respiratory chain of the electricigenic microbes are transferred to the anode 4, and a current in an external circuit flows from the cathode 5 to the anode 4. A current in an internal circuit flows from the anode 4 to the cathode 5, sea water with a salt content of 20 g/L continuously flows into the middle desalting compartment B, and due to the selectivity of the anion exchange membrane 2 and the cation exchange membrane 3, anions and cations are transferred to the anode compartment A and the cathode compartment C through the anion exchange membrane 2 and the cation exchange membrane 3 under the action of an electric driving force respectively to achieve a desalting process. Electrons in the external circuit transferred to the cathode 5 are combined with an electron acceptor such that a reduction reaction may take place and a current generation may be accomplished.

At present, with the MFC according to an embodiment of the present disclosure, an to output power is about 300 W/m³, a wastewater treatment load is 5 kg/m³d, a running current is about 100 mA, and a desalination rate is 90 mM/d. With the development of the MFC technology, the increase of the current will continuously increase the desalination rate.

1. A wastewater treatment process for generating current and desalting simultaneously, comprising steps of:
(a) providing a device comprising
a microbial fuel cell which is divided into an anode compartment, a middle desalting compartment and a cathode compartment by an anion exchange membrane and a cation exchange membrane respectively provided therein;
an anode disposed in the anode compartment with an electricigenic biofilm disposed on the anode;
a cathode disposed in the cathode compartment; and
an external circuit connecting the cathode and the anode;
(b) oxidizing wastewater flowing into the anode compartment under the action of electricigenic microbes to remove contaminants from the wastewater, transferring electrons in a respiratory chain of the electricigenic microbes to the anode via an external circuit with a current therein flowing from the cathode to the anode;
(c) continuously supplying saline water into the middle desalting compartment with a current in an internal circuit connecting the cathode and the anode inside the microbial fuel cell flowing from the anode to the cathode, and due to the selectivity of an anion exchange membrane and a cation exchange membrane, transferring anions and cations in the microbial fuel cell being transferred to the anode compartment and a the cathode compartment through the anion exchange membrane and the cation exchange membrane under the action of an electromotive force respectively for desalting; and
(d) combining electrons in the external circuit transferring to the cathode with an electron acceptor to undertake a reduction reaction, for generating electricity.

2. The wastewater treatment process according to claim 1, wherein the wastewater is organic wastewater capable of being treated biochemically.

3. The wastewater treatment process according to claim 1, wherein the electricigenic microbe comprise Geobacter and Shewanella.

4. The wastewater treatment process according to claim 1, wherein the saline water comprises: sea water or brackish water with a salt content of 5-35 g/L.

5. The wastewater treatment process according to claim 1, wherein the electron acceptor comprises oxygen and potassium ferricyanide for chemically catalytic reduction as well as oxygen, nitrate and carbon dioxide for microbially catalytic reduction.

6. A wastewater treatment device for generating current and desalting simultaneously, comprising:
a microbial fuel cell being divided into an anode compartment, a middle desalting compartment and a cathode compartment by an anion exchange membrane and a cation exchange membrane provided therein;
an anode disposed in the anode compartment with an electricigenic biofilm disposed on the anode;
a cathode disposed in the cathode compartment with an electron acceptor; and
an external circuit connecting the cathode and the anode, wherein
wastewater is supplied into the anode compartment whereas saline water is continuously flowing into the middle desalting compartment.

7. The wastewater treatment device according to claim 6, wherein the anion exchange membrane and the cation exchange membrane are a non-toxic industrial electrodialysis ion exchange membrane with a transmissivity not less than 90%, a thickness of 0.2-0.5 mm, and a bursting strength not less than 0.3 MPa.

8. The wastewater treatment device according to claim 6, wherein the electricigenic biofilm on the anode has a thickness of 20-80 μm.

9. The wastewater treatment device according to claim 6, wherein the anode and a filling material in the anode compartment comprise graphite particles, carbon felt or coke with a particle diameter of 1-5 mm.

10. The wastewater treatment device according to claim 6, wherein the cathode and a filling material in the cathode compartment comprise graphite particles, carbon felt or coke with a particle diameter of 1-5 mm.

11. The wastewater treatment device according to claim 6, wherein the electricigenic microbe comprise Gobacter and/or Shewanella.

12. The wastewater treatment device according to claim 6, wherein the electron acceptor comprises oxygen and potassium ferricyanide for chemically catalytic reduction as well as oxygen, nitrate and carbon dioxide for microbially catalytic reduction.
